(19) United States
(12) Patent Application Publication
(10) Pub. No.: US 2009/0160344 A1
(43) Pub. Date: Jun. 25, 2009

(54) LIGHTING EMITTING DIODE LAMP

(75) Inventors: Hung-Kuang Hsu, Chu-Nan (TW); Chun-Wei Wang, Chu-Nan (TW); Wen-Jang Jiang, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/040,830

(22) Filed: Feb. 29, 2008

(30) Foreign Application Priority Data
Dec. 21, 2007 (CN) 200710203325.X

(51) Int. Cl. H01J 61/52; H01J 13/32

(52) U.S. Cl. 315/117; 315/113

(57) ABSTRACT

A lighting emitting diode (LED) lamp (100) includes a first LED array (60) and a second LED array (50). A ratio of change of relatively luminous intensity relative to change of temperature of the first LED array is less than that of the second LED array. A first heat sink (10) thermally attaches to the first LED array. A second heat sink (20) thermally attaches to the second LED array. An active heat dissipating device (80) is in combination with the second heat sink for enhancing a heat dissipation efficiency of the second heat sink, and thus the heat dissipation efficiency of the second heat sink is greater than that of the first heat sink. The heat dissipation of the second LED array is much quicker than that of the first LED array. The second LED array thus can be kept working at a much less temperature.

### CROSS-REFERENCE TO RELATED APPLICATION

This application is related to a co-pending application entitled a same title with the present application, assigned to the same assignee of this application and filed on the same date. The disclosure of the co-pending application is wholly incorporated herein by reference.

### BACKGROUND OF THE INVENTION

1. Field of the Invention

The present invention relates generally to a light emitting diode lamp, and particularly to a heat dissipation device of the lamp.

2. Description of Related Art

In recent years, light emitting diodes (LEDs), because of being highly efficient light sources, have come to be widely used in such fields as automotive transport, display screens, and traffic control indicators.

It is well known that LEDs emit light within a relatively narrow-band spectrum. Therefore, LEDs are inherently suited as sources of colored light, whereas many applications require white light with a broad spectrum. Two basic approaches for producing white light rely on either partial or complete conversion of short-wave radiation from LED chips or using a variety of independently controlled primary colored LEDs. During operation, when the variety of colored LEDs give off light, heat is also produced, and thus the working temperature of the LEDs increases. However, rates of change of the luminous intensity of the variety of colored LEDs relative to their respective working temperature are much different from each other. For example, the luminous intensity of the red LEDs, the yellow LEDs or the orange LEDs decreases much more than that of the blue LEDs for equal increases in working temperature. Color, luminance, and color temperature of the white light thus are much affected by change of the red LEDs. Therefore a heat dissipation device is needed to keep the variety of colored LEDs working at different suitable working temperatures.

Therefore, a heat dissipation device for the LED lamp is desired to overcome the above describe shortcomings.

### SUMMARY OF THE INVENTION

In accordance with the present embodiment, a light emitting diode (LED) lamp includes a circuit board, first and second LED arrays electrically connected with and thermally attached to one side of the circuit board, and first and second heat sinks thermally attached to an opposite side of the circuit board. A ratio of change of luminous intensity relative to change of temperature of the first LED array is less than that of the second LED array. The first heat sink thermally attaches to the first LED array, and the second heat sink thermally attaches to the second LED array. A fan is provided for use in combination with the second heat sink for enhancing a heat dissipation efficiency of the second heat sink, and thus the heat dissipation efficiency of the second heat sink is greater than that of the first heat sink.

Other advantages and novel features of the present invention will be drawn from the following detailed description when taken in conjunction with the accompanying drawings in which:

### BRIEF DESCRIPTION OF THE DRAWINGS

FIG. 1 is an assembled, cross-sectional view of a light emitting diode (LED) lamp according to a preferred embodiment of the present invention;

FIG. 2 is a graph indicating a relationship of a relative luminous intensity of different colored LEDs and working temperature thereof;

FIG. 3 is similar to FIG. 1, but shows an alternative embodiment of the LED lamp; and

FIG. 4 shows the LED lamp according to a third embodiment of the present invention.

### DETAILED DESCRIPTION OF THE INVENTION

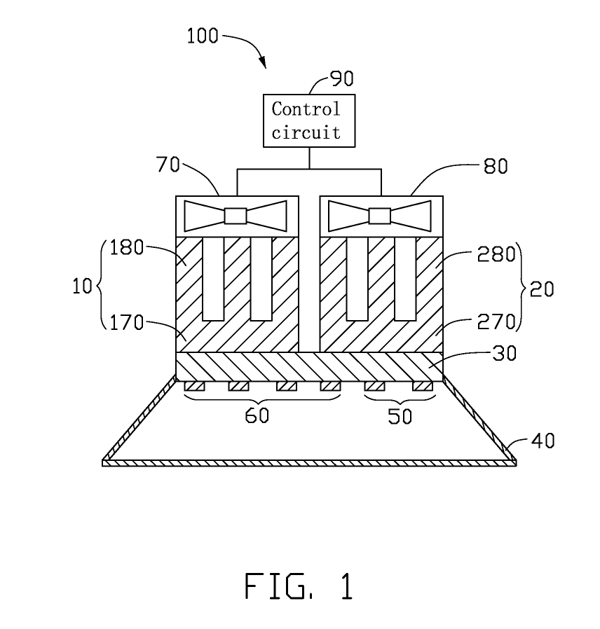

The detailed explanation of a light emitting diode (LED) lamp 100 according to the present invention will now be made with reference to the drawings attached hereto. Referring to FIG. 1, the LED lamp 100 includes a substrate 30, a light source arranged on the substrate 30, a heat dissipation device, and a reflecting shell 40.

In this embodiment, the substrate 30 is a metal core printed circuit board (MCPCB). A plurality of circuits (not shown), are printed on the substrate 30 for electrically connecting the light source thereon. The MCPCB is usually made of aluminum, which has a much larger heat conductivity coefficient to enhance heat transfer efficiency between the light source and the substrate 30. It is to be understand that the substrate 30 is not limited to be MCPCB, a conventional PCB or a ceramic PCB is also can be adopted. The light source includes a plurality of LEDs being electrically connected with the circuitry of the substrate 30 through wire bonding or flip chip. The reflecting shell 40 is mounted around the light source.

In this embodiment, the light source includes two LED arrays 50, 60. The LED array 60 emits blue light and is made of GaInN or GaN, with a wavelength in a range of 450˜470 nm. The LED array 50 emits red light and is made of AlInGaP or GaAs, with a wavelength in a range of 610˜635 nm. A plurality of yellow phosphor particles are arranged outside each blue LED chip of the blue LED array 60. A part of the blue light emitted by the blue LED chip is absorbed by the phosphor particles and is converted to yellow light. The remaining part of the blue light mixes with the yellow light and is perceived as white light. The red LED chip radiates red light, which mixes with the white light to improve a color-rendering index of the white light.

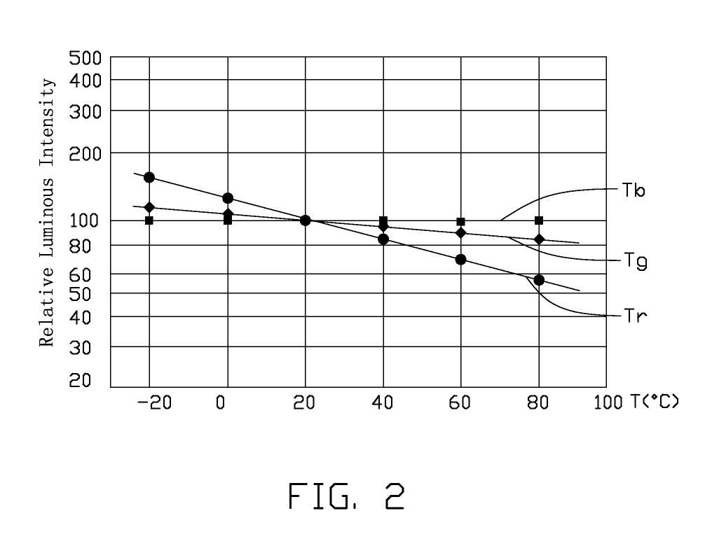

FIG. 2 shows a relationship of relative luminous intensity of different colored LEDs and working temperature thereof. Lines Tb, Tg, and Tr respectively show change in relative luminous intensity of a blue LED, a green LED, and a red LED according to the working temperature. When the working temperature increases to 80° C., the relative luminous intensity of the blue LED is substantially constant, and the relative luminous intensity of the green LED only decreases by about 15%. However, as the working temperature increases to 80° C., the relative luminous intensity of the red LED decreases by about 45%, whereas, if the working temperature does not exceed 40° C., decrease in the relative luminous intensity of the red LED is not higher than 15%. Thus the working temperature of the red LED should be kept much less than that of the blue LED or the green LED, which is also suitable for yellow and orange LEDs.

The heat dissipation device is thermally attached to the substrate 30 to dissipate the heat of the LED arrays 50, 60. In this embodiment, the heat dissipation device includes a first fin-type heat sink 10 arranged to cool the blue LED array 60, and a second fin-type heat sink 20 arranged to cool the red LED array 50. Each of the heat sinks 10, 20 is an extruded aluminum heat sink, including a base 170, 180 and a plurality of fins 180, 280. First and second cooling fans 70, 80 are respectively arranged on the first and second heat sinks 10, 20 for enhancing heat dissipation efficiency of the heat sinks 10, 20. A control circuit 90 is electrically connected with the cooling fans 70, 80 for controlling a rotation speed of the cooling fans 70, 80. The rotation speed of the second cooling fan 80 is greater than that of the first cooling fan 70. Thus heat exchange between the second heat sink 80 and the ambient air is greater than that of the first heat sink 70. Heat dissipation efficiency of the second heat sink 20 is thus greater than that of the first heat sink 10. As the first heat sink 10 is arranged on the blue LED array 60, and the second heat sink 20 is arranged on the red LED array 50, heat dissipation of the red LED array 50 is much quicker than that of the blue LED array 60. The red LED array 50 can thus be kept at a much less working temperature.

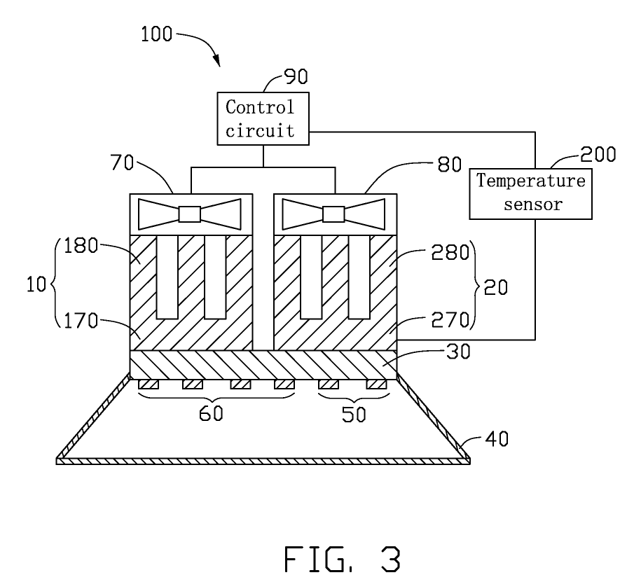

FIG. 3 shows an alternative embodiment of the present invention. The difference between this embodiment and the first embodiment is that a temperature sensor 200 is configured for sensing a temperature of the second heat sink 20 and feeding back the temperature signal of the second heat sink 20 to the control circuit 90 to control the rotation speed of the second cooling fan 80 more precisely. Thus the rotation speed of the second cooling fan 80 can be adjusted according to the temperature of the second heat sink 20, which can maintain the red LED array 50 working at a more suitable temperature.

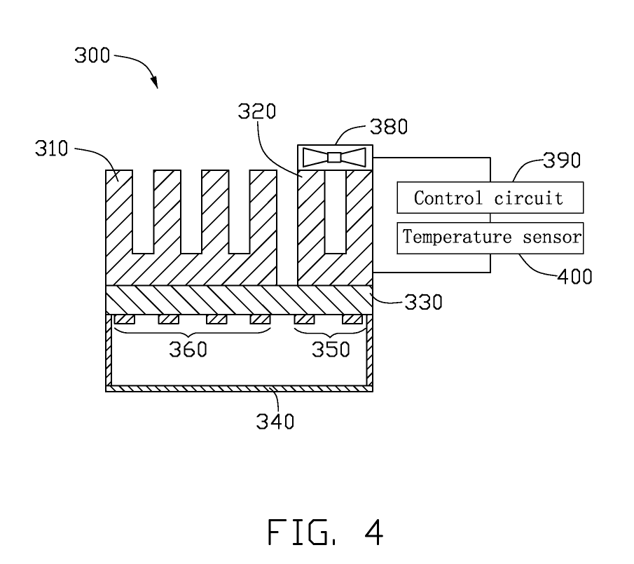

Referring to FIG. 4, an LED lamp 300 according to a third embodiment is shown. The light source of the LED lamp 300 has LEDs in four different colors, which include a plurality of blue LEDs, green LEDs, yellow LEDs, and red LEDs. The different colored LEDs are electrically connected with and thermally attached to a substrate 330. A dispersion shell 340 is mounted around the LEDs to mix the light radiated by the different colored LEDs to produce white light. The blue LEDs and the green LEDs form a first LED array 360, and the yellow LEDs and the red LEDs form a second LED array 350. A first heat sink 310 is arranged on the substrate 330 corresponding to the first LED array 360, and a second heat sink 320 is arranged on the substrate 330 corresponding to the second LED array 350. In this embodiment, only a cooling fan 380 is arranged on the second heat sink 320 for enhancing heat exchange between the second heat sink 320 and the ambient air, to improve heat dissipation efficiency of the second heat sink 320. Also a temperature sensor 400 is adopted for sensing the temperature of the second heat sink 320, and a control circuit 390 interconnects the temperature sensor 400 and the cooling fan 380 to precisely control the rotation speed of the cooling fan 380. The heat dissipation efficiency of the second heat sink 320, working in combination with the cooling fan 390 is greater than that of the first heat sink 310, which has no fan assist. Heat dissipation of the second LED array 350 is much quicker than that of the first LED array 360. The red LEDs and the yellow LEDs thus can be kept at a much less working temperature as desired. It is to be understood that the cooling fan is adapted for enhancing the heat dissipation efficiency of the heat sink, other type heat dissipating devices, such as thermoelectric coolers, refrigerators, which can actively dissipate heat are also suitable.

It can be understood that the above-described embodiment are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. A light emitting diode lamp, comprising:
a first light emitting diode array;
a second light emitting diode array, a ratio of change of luminous intensity relative to change of temperature of the first light emitting diode array being less than that of the second light emitting diode array;
a first heat sink thermally attached to the first light emitting diode array;
a second heat sink thermally attached to the second light emitting diode array; and
an active heat dissipating device in combination with the second heat sink for enhancing a heat dissipation efficiency of the second heat sink, and the heat dissipation efficiency of the second heat sink being greater than that of the first heat sink.

2. The light emitting diode lamp of claim 1, wherein the active heat dissipating device is a cooling fan.

3. The light emitting diode lamp of claim 2 further comprising a temperature sensor and a speed control circuit, the temperature sensor configured for sensing the temperature of the second heat sink and feeding the temperature back to the control circuit to control a rotation speed of the fan.

4. The light emitting diode lamp of claim 1 further comprising a second active heat dissipating device in combination with the first heat sink for enhancing the heat dissipation efficiency of the first heat sink.

5. The light emitting diode lamp of claim 1 further comprising a metal core printed circuit board arranged between the heat sinks and the light emitting diode arrays, the first and second light emitting diode arrays being electrically connected with and thermally attaching to the metal core printed circuit board.

6. The light emitting diode lamp of claim 1, wherein the first light emitting diode array includes at least one blue light emitting diode for emitting blue light, and the second light emitting diode array includes at least one red light emitting diode for emitting red light.

7. The light emitting diode lamp of claim 6, further comprising a reflecting shell mounted around the first and second light emitting diode arrays, a plurality of yellow phosphor particles are arranged outside each blue LED chip to convert the blue light of the blue light emitting diode to yellow light, the yellow light mixed with the blue light and the red light to produce white light.

8. The light emitting diode lamp of claim 1, wherein the first light emitting diode array includes at least one blue light emitting diode and at least one green light emitting diode, and the second light emitting diode array includes at least one red light emitting diode and at least one yellow light emitting diode.

9. The light emitting diode lamp of claim 8, further comprising a dispersion shell mounted around the first and second light emitting arrays to mix the light emitted from the different colored light emitting diodes to produce white light.

10. A light emitting diode lamp, comprising:
a circuit board;
first and second light emitting diode arrays electrically connected with and thermally attached to one side of the circuit board, a ratio of change of intensity relative to change of temperature of the first light emitting diode array being less than that of the second light emitting diode array;
first and second heat sinks arranged on an opposite side of the circuit board, and thermally attached to the first and second light emitting diode arrays, respectively;
a fan in combination with the second heat sink for enhancing a heat dissipation efficiency of the second heat sink, and the heat dissipation efficiency of the second heat sink being greater than that of the first heat sink.

11. The light emitting diode lamp of claim 10 further comprising a temperature sensor and a speed control circuit, the temperature sensor configured for sensing the temperature of the second heat sink and feeding the temperature back to the control circuit to control a rotation speed of the fan.

12. A light emitting diode lamp, comprising:
a circuit board;
first and second light emitting diodes electrically connected with and thermally attached to one side of the circuit board, a ratio of change of intensity relative to change of temperature of the first light emitting diode being less than that of the second light emitting diode;
first and second heat sinks arranged on an opposite side of the circuit board, and thermally attached to the first and second light emitting diodes, respectively;
a fan in combination with the second heat sink for enhancing a heat dissipation efficiency of the second heat sink, and the heat dissipation efficiency of the second heat sink being greater than that of the first heat sink.

13. The light emitting diode lamp of claim 12 further comprising a temperature sensor and a speed control circuit, the temperature sensor configured for sensing the temperature of the second heat sink and feeding the temperature back to the control circuit to control a rotation speed of the fan.
